(19) United States
(12) Patent Application Publication
(10) Pub. No.: US 2016/0372091 A1
(43) Pub. Date: Dec. 22, 2016

(54) Brass Instrument Mouthpiece Warmer

(71) Applicant: David Michael Tini, Altoona, PA (US)

(72) Inventor: David Michael Tini, Altoona, PA (US)

(21) Appl. No.: 14/740,470

(22) Filed: Jun. 16, 2015

(51) Int. Cl. G10D 9/02; H05B 3/02; H05B 3/16; H05B 3/06; H05B 3/00; H05B 3/14

(52) U.S. Cl. CPC G10D 9/02; H05B 3/0014; H05B 3/148; H05B 3/16; H05B 3/06; H05B 3/02

(57) ABSTRACT

A musical brass instrument mouthpiece warmer includes a mouthpiece in combination with a heater for warming. The warmer is positioned around the mouthpiece with an electrical power source for activation. Whereby, provides power to the warmer for heating the mouthpiece when temperatures are cold to the user's preference. The warmer covers the cup and shank of the mouthpiece and the battery pack is attached to the horn. When activated, the warmer generates heat that warms the mouthpiece. The warmer is adapted to be removable from the horn when the user chooses not to use the warming device.

### REFERENCES CITED

U.S. PATENT DOCUMENTS

| U.S. Pat. No. 1,481,855 | 1/1924 Bach | 84/387R |
|---|---|---|
| U.S. Pat. No. 4,742,755 | 5/1988 Peterson | 84/453 |

### BACKGROUND OF THE INVENTION

1. Field of the Invention

The present invention relates to a musical instrument warmer and more particularly pertains to providing a covering for the mouthpiece to heat brass instrument mouthpiece.

2. Description of the Prior Art

The use of musical instrument heating is known in the prior art, specifically musical instrument heating for the purpose of warming for a multitude of objectives and requirements.

For example, U.S. Pat. No. 5,920,022 to Ashwood discloses a warming system that uses an inclusive instrument warming apparatus. With heating elements, fabric, and portable power Ashwood's instrument warmer focused on the entire instrument. Although Ashwood's invention heats brass instruments portably, the invention reduces the resonance of brass instruments by placing fabric on the entire instrument.

For example, U.S. Pat. No 5,253,563 to Smith discloses a universal system for heating that was structured to support one or more instrument. Smith's heater promoted passive heat. Although Smith's invention heats brass instruments it is not portable.

For example, U.S. Pat. No. 4,926,735 to Smith discloses a heated rotating musical instrument stand. With multiple mounting stations, Smith's invention supported multiple instruments at once. Although Smith's invention heats brass instruments it is not portable.

For example, U.S. Pat. No. 4,529,865 to Oakes discloses an individual heated musical instrument stand. Although Oakes' invention heats brass instruments it is not portable.

U.S. Pat. No. 4,742,755 to Peterson uses a heating attachment for the mouthpiece of a musical instrument. The battery is located within the sleeve. Although Peterson's invention is both portable and does not reduce the resonance of the entire instrument, the battery is located within the warming sleeve and is incapable of lasting for extensive time periods, which would fail at being a feasible option as a sustainable option.

These heating devices are totally unlike the heating elements and characteristics of the present invention. Therefore, there exists a need for the art for a brass instrument mouthpiece warmer that is portable, sustainable, easily constructed, usable during performance, and enabling the musician to perform in cold weather without physical discomfort.

While these devices fulfilled their individual objectives, the aforementioned patents did not describe a warmer that allows the instrument to maintain maximum resonance. Certain aforementioned patents were not portable and none addressed all the fundamental issues of portable heating, sustainability, and maximum resonance of the instrument.

This present invention dramatically departs from the previous art and designs to meet all objectives without the drawbacks of other designs. Therefore, it can be appreciated that there continues to exist a need for new and improved brass instrument mouthpiece warmers in cold weather providing portable heat for brass instrument mouthpieces for a sustainable amount of time, that does not decrease the resonance of the instrument, all while enabling the musician to perform without discomfort in cold environments.

### SUMMARY OF THE INVENTION

This invention relates to the warming attachment for a brass musical instrument. A brass musical instrument includes Trumpets, Comets, Mellophones, French Horns, Trombones, Euphoniums, Baritones, and Tubas. When brass instruments are played in cold temperatures, a range determined by the discomfort of the musician; however most would consider a cold temperature to play as sub-mid 40°s Fahrenheit, the player often experiences physical discomfort that reduces the player's ability to operate the instrument.

Therefore, it is the objective of the present invention to provide a heating mechanism that can be attached to the mouthpiece to maintain the mouthpiece above the ambient air temperature.

It is another objective of the present invention to utilize battery power sources to create a portable and reusable warming device.

It is another objective of the present invention to prevent the player from experiencing discomfort while playing in cold temperatures.

It is another objective of the present invention to provide a warming device that can attach and detach from brass instrument mouthpieces.

To attain this, the present invention a brass musical instrument mouthpiece with a cover for warming and a battery pack for powering the system. The system has two portions; the body of the battery pack which has a front and rear side that is in a general rectangular shape. The top side with a switch for powering on and off the system and the rear side that has a panel that allows the user access to load batteries. The heater portion of the system is attached to the battery pack with wire leads that enter the heating elements. The heating element is formed into a hollow cylinder that the brass instrument mouthpiece slides into the center to transfer heat. The outside layer of the heating element is covered with hook and loop for mounting and securing the heating element to the mouthpiece.

It is therefore the object of the present invention to provide a new and improved brass instrument mouthpiece heater that meets these objectives and none of the disadvantages of the other aforementioned patents.

It is a separate objective of the present invention to provide a low cost replicable product for low sales prices for the publics consumption.

With these and other objects in view, as will be apparent to those skilled in the art, the invention resides in the combination of parts set forth in the specification and covered by the claims appended hereto.

### BRIEF DESCRIPTION OF THE DRAWINGS

The present invention will be better understood and more apparent when consideration is given to the following detailed description. Such description makes reference to the annexed drawings wherein:

FIG. 1 is a side view of the brass instrument mouthpiece warmer with the principles of the present invention.

FIG. 2 is a cutaway of the cross sectional of FIG. 1 taken along line 2-2 of FIG. 1.

FIG. 3 is a is a front view.

FIG. 4 is a perspective view of the preferred embodiment of the brass instrument mouthpiece warmer constructed with accordance and the principles of the present invention.

### DESCRIPTION OF THE PREFERRED EMBODIMENT

With reference now to the drawings, and in particular to FIG. 4, the preferred embodiment of the new and improved invention will be described.

The present invention, the brass instrument mouthpiece warmer, is comprised of a plurality of components, which in broadest context include a brass instrument, a means of heating, and a source of power. Each component is organized individually to achieve the previously stated objectives.

The present invention includes a brass instrument 10 in combination with the brass instrument mouthpiece drawings 1 and the brass instrument mouthpiece warmer. The brass instrument consists of any instrument made of brass consisting of mouthpiece playing apparatus 1. The brass instrument mouthpiece warmer is made from a silicone heating element for weather proof heating.

The beating element 2 is powered through battery power, supplied from a low profiled battery pack 5. The battery 5 transmits enemy through wire leads 3 to the heating element 2. As seen in FIG. 2, the heating element 6, which transfers heat to the mouthpiece 1. To insulate the heat created in the heating element, a insulating cover of hook and loop material 7 covers the heating element 6.

The hook and loop material 7 serves with a dual purpose of insulation and also securing the heating element 6 to the mouthpiece 1. Once the heating element 6 is mounted to the mouthpiece 1, the mouthpiece is mounted into the trumpet as seen in FIG. 4 by inserting the mouthpiece shank 4 into the trumpet lead pipe 9.

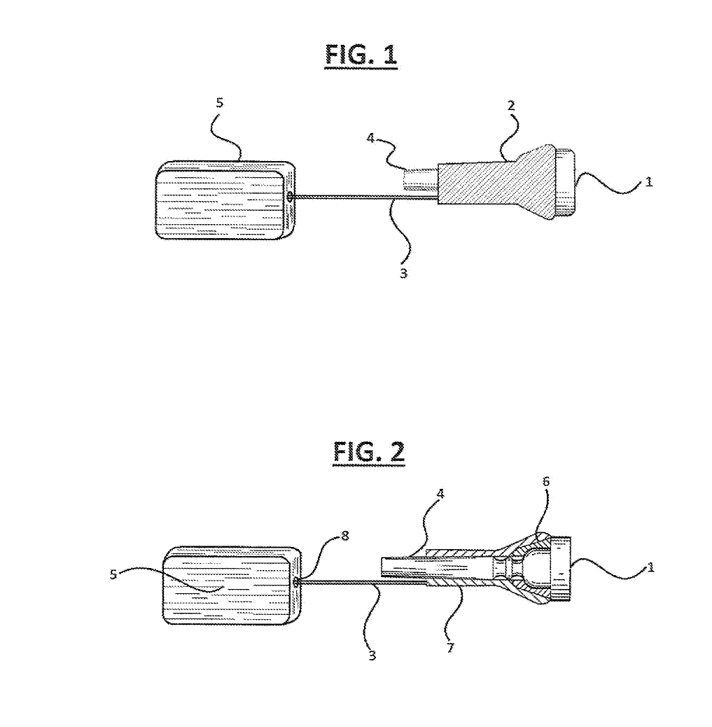

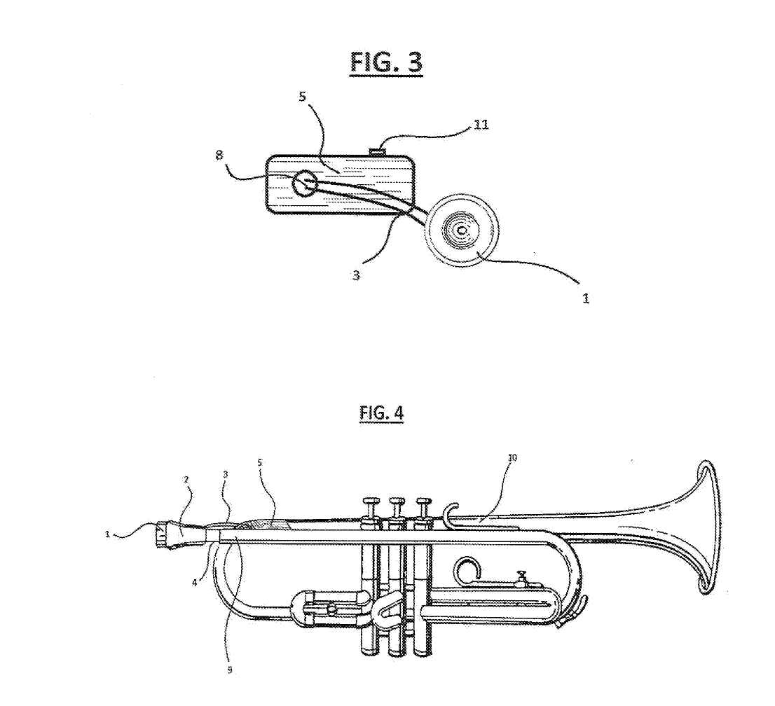

To control the device, the user is able to turn on and off the brass instrument mouthpiece warmer as seen in FIG. 3 with an off and on switch IL The preferred embodiment of only the brass instrumental warmer is viewable through FIG. 1, showing the outside heating element and the hook arid loop insulation 2, fitted on the mouthpiece 1, powered through the wire leads 4, and battery pack 5.

1. An improved universal brass instrument mouthpiece heating system comprising in combination:
a battery pack as a source of energy to power heating elements which attach to the user or instrument that enables a portable mouthpiece warmer,
electrical circuitry including a switch and the ability to control the heating element of the present invention,
a section of wire leads carrying the battery pack energy to the heating element.
a generally cylindrical cover for warming the brass mouthpiece that attaches to the brass mouthpiece with a generally identical structure,
an electric heating element within the cylindrical cover, and
a manner in which to attach the system to either the user or the instrument.

2. A heating system as recited in claim 1, wherein said battery pack and said source of energy consists of a battery(ies).

3. A heating system as recited in claim 1, wherein said heating element is a silicone heater with an improved layer of insulation to contain warmth from the heating element.
